(19) United States
(12) Patent Application Publication
(10) Pub. No.: US 2009/0137410 A1
(43) Pub. Date: May 28, 2009

(54) METHOD FOR COMPUTER-BASED PROCESSING OF BIOLOGICAL DATA

(76) Inventors: Oliver Schmitz, Dallgow-Doberitz (DE); Alfons Weig, Falkensee (DE); Mathieu Klein, Berlin (DE); Uwe Pressler, Waldsee (DE); Alexander Levin, Edingen-Neckarhausen (DE); Florian Schauwecker, Berlin (DE); Udo Kampf, Friedrichsdorf (DE); Anke Eisenmann, Limburgerhof (DE)

Correspondence Address: CONNOLLY BOVE LODGE & HUTZ, LLP, P O BOX 2207, WILMINGTON, DE, 19899, US

(21) Appl. No.: 12/299,480

(22) PCT Filed: May 8, 2007
(86) PCT No.: PCT/EP07/04043

§ 371 Date: Nov. 4, 2008

Related U.S. Application Data
(60) Provisional application No. 60/798,571, filed on May 8, 2006.

(51) Int. Cl. C40B 30/02; C40B 60/12; C40B 60/04

(52) U.S. Cl. 506/8; 506/39; 506/35

(57) ABSTRACT

A method for computer-based processing of biological data, comprising the steps of: selecting a gene as lead gene to be patented; searching homologues for the selected lead gene; creating a patent pool on the basis of the selected lead gene; generating and outputting a pool report for the planned patent application.

### FIELD OF THE INVENTION

The present invention relates to the field of data processing and data management of biological data.

The present invention is further related to the field of automated evaluation and preparation of data for patent applications directed on biological sequences. Moreover, the present invention relates to a method to reduce the costs in handling large volume data of gene and protein sequences to be patented.

### DESCRIPTION OF THE RELATED ART

In the field of biology or biotechnology, very often large volumes of data have to be handled when a patent application is to be prepared as a sequence of a gene or a protein is not filed and claimed alone but rather as a lead gene together with its homologues. This may result in a burdensome work for all involved, scientists, administrative staff as well as the patent attorney charged with drafting the application and preparing the documents for filing.

Biotechnology is a highly automated field of technology. Particularly in the area of managing and presenting information relating to genetic information and the comparison of sequences, a high number of computer-based tools are available to the scientists. However, the existing tools, such as described for example in WO 00/50889 A1, US 2005/0228595 A1 or in JP 2004-280614 A, merely assist the scientist in identifying relevant genes or evaluating the industrial usability of genes or proteins. Once the scientist has identified a given sequence as one to be patented, all the relevant information necessary for the preparation of a patent application, and particularly the information needed to set up documents in accord with the World Intellectual Property Organization Standard 25 (WIPO St25) form required when applying for patents on sequences, have to be gathered and brought together manually. This is, as already pointed out, a burdensome work which increases the costs for the intended patent application. Additionally, the information and the data to be put together is very complex, and thus highly error-prone. However, mistakes in patent applications can be fatal as they are likely to lead to the invalidity of the according patent which has to be avoided for reasons of protection of research investments and also in view of the expenses for patenting.

Further, it might be essential to file a patent application as fast as possible in order to secure intellectual property rights and research investments, particularly in view of so-called first-to-file legislations. Thus, rapidity in the gathering and processing of patent relevant data is a very important issue.

A further aspect of the invention relates to the fact that patent claims are only granted on full and functional sequences. However, a considerable number of sequences patent protection should be seeked for does not fulfill this requirement. Complete and partial cDNA nucleotide sequences typically derive from isolated mRNA sequences, and are commonly used for sequencing and determination of gene expression. cDNA sequences in this context are also referred as Expressed Sequence Tags (ESTs) hereafter. In many higher organisms, the sequence of a protein cannot be easily concluded from pure genomic sequences; sometimes, non-coding segments (introns) have to be removed from coding segments (exons) during in vivo mRNA processing (splicing), finally resulting in a directly protein encoding nucleotide sequence. Progress has been made in prediction and detection of intron/exon structures in genomic DNA sequences. However, the most commonly used sequence type to get reliable information about the protein sequence, are cDNA sequences.

In many cases, cDNA sequences are partial because they do not cover the whole length of the encoded protein, which for example can be the result from in vivo and in vitro mRNA degradation during cDNA synthesis. As a solution one can combine all available cDNA sequences from the same gene, which might cover different regions of that gene, to form a single, more complete nucleotide sequence, e.g. by using computer sequence assembly programs. This can easily be done from a large number of otherwise uncharacterized ESTs, resulting in combined sequences, also called “EST-assemblies”. Even those EST assemblies per-se provide more information than a single EST, it is not guaranteed that an EST-assembly provides the complete sequence for the final gene product. Especially the information about the 5-prime end of larger genes is more difficult to obtain, since mRNAs are very prone to in vivo 5-prime degradation. In addition, ESTs and EST-assemblies can harbour sequence errors, which are desired to be curated.

Accordingly, there is a need for a method and a system to reduce the work and the costs involved with the preparation of patent applications on sequences. There is also a need for a method and a system which allows scientists to process sequence data for securing intellectual property rights as broadly as possible before a patent attorney is involved. Moreover, there is a need for a method and a system to accelerate the preparation of patent relevant sequence information and data in standardized formats.

Further, there is a need to provide a method which allows to complete incomplete or partial sequences, particularly at their 5-end.

### SUMMARY OF THE INVENTION

The present invention provides a method of managing data related to biological sequences wherein for each sequence selected for patenting (and thus identified as a lead sequence for a patent application), a data substructure is created. This data substructure hereinafter is called a patent pool. In this patent pool, all additional sequence related data required for the planned patent application is gathered in a systematic manner, thus enabling a user to generate automatically the documents for the patent application in the standardized format.

The invention can be implemented as a software tool, i.e. as a computer program running on a suitable computer system or computer network system. In the following, each possible embodiment or form of appearance of the present invention, be it in the form of a computer program, of a computer system, of a network system, of a database system or any other possible form, is referred to as Patent Tool.

The method of the invention thus helps to manage a database consisting of genes selected for patenting and homologous sequences from public or proprietary databases. In addition, other sequences, like primer sequences, consensus sequences and sequence patterns can be linked to the primary (or lead) sequence. Furthermore, several primary sequences exhibiting a similar function can be grouped together into a pool for an individual patent application. However primary sequences can be processed without being associated with a pool. WIPO St25 sequence formats can be produced from the pools and used in the patent application.

According to one aspect of the invention, primary sequences, e.g. a protein sequence, can be identified in sequence databases directly or through search tools like the BioRS system (Biomax, Martinsried, Germany) and uploaded to the Patent Tool, e.g. by a semiautomated procedure. During upload, the Patent Tool tries to identify corresponding nucleotide sequences to selected protein sequences either by identifying cross-references in the protein database entries or by starting a TBlastN (Altschul et al., J. Mol. Biol. 215:403-410 (1990)) database search. In the latter case, the corresponding nucleotide sequence shall be loaded to Patent Tool manually to assure the selection of the correct DNA sequence.

According to a further aspect of the invention, homologous sequences to primary sequences can be identified via sequence homology searches, like Blast searches (Altschul et al., J. Mol. Biol. 215:403-410 (1990); “Gapped BLAST and PSI-BLAST: a new generation of protein database search programs”, Altschul, Stephen F., Thomas L. Madden, Alejandro A. Schaffer, Jinghui Zhang, Zheng Zhang, Webb Miller, and David J. Lipman (1997), Nucleic Acids Res. 25:3389-3402) against selected nucleotide or protein databases. The search results can be visualized and sorted according to their similarity to the query sequence and selected database hits can be uploaded to the Patent Tool as patent homologues. Similar to the above-described upload of primary sequences, the Patent Tool tries to identify corresponding nucleotide sequences (with the primary sequence being an amino acid sequence) either by cross-references in the protein database entries or by a TBlastN database search. Further, other sequences like Primers, useful for the planned patent application also can be uploaded to the Patent Tool.

According to still another aspect of the invention, so-called consensus sequences can be deduced from multiple sequence alignments created outside the Patent Tool. If applicable, conversions can be performed by means of known and available conversion tools. Protein patterns can be defined from conserved regions taken from the multiple alignment. Consensus sequences and patterns can then be uploaded to Patent Tool. Patent Tool stores these data within a context in the Patent Pool (e.g. a consensus sequence has zero to several patterns associated and patterns cannot exist without a consensus sequence). Importantly also consensus sequences and patterns can be transformed into required output formats, like the WIPO St25 standard.

The invention also allows for a pattern evaluation by comparing patterns to the primary and homologous sequences as well as performing a database search with patterns. As a result, the user can identify those patterns which match best with the primary and homologous sequences. Furthermore, additional database hits exhibiting the patterns (if more than one has been selected for evaluation) can be selected as homologues sequences which were not taken from the Blast database search. These database entries can be added to the list of homologues.

Further, the invention provides that sequences used for patent applications (like primary and homologous sequences, primers, consensus and patterns) can be exported into the official WIPO St25 sequence format or any other format as defined by WIPO or other relevant authorities. Both protein and/or nucleotide sequences are used for primaries and homologues. In addition, an Excel® overview can be generated as well as sequence files in different file formats (e.g. FASTA, EMBL, GenBank). Furthermore, an overview of Sequence IDs used in the WIPO format is provided as part of the Excel® export file.

Thus, the invention enables a scientist or other user to accelerate the preparation of sequence information prior to patenting, to ensure a high-quality handling of large number of sequences and to increase efficiency of the patenting process by significantly reducing the time needed for fulfilling the application requirements. It also helps to save time and resources at the patent attorney's side.

Another advantage of the present invention lies in the modular design of the Patent Tool which allows for an efficient handling of lead gene sequences and homologues sequences as well as gene information in various and different contexts of different patent applications, i.e. the use of relevant information over a variety of different patent applications becomes possible. E.g. the Patent Tool allows for a linking of primary sequences with their associated sequences to different patent pools.

The invention provides for
storage and organization of patent-relevant sequence information
standardized handling of DNA and protein sequences (including patterns and consensus sequences)
Identification and selection of homologues by sequence similarity search
Evaluation of protein patterns and identification of additional homologues by database search using any combination of patterns
Use of public and proprietary data bases
Link to databases directly or through retrieval systems like BioRS™ (Biomax, Martinsried, Germany) Integration and Retrieval System and to sequence analysis systems like, the Pedant-Pro™ Sequence Analysis Suite (BioMax, Martinsried, Germany)
preparation of sequences according to World Intellectual Property Organization Standard 25 (WIPO St25)

Adaptations to other useful output standards are likewise easily achievable.

According to still a further aspect of the invention, a method is provided which allows to automatically convert a partial gene sequence into a complete chimeric full-length gene sequence. According to the invention, a partial cDNA gene sequence (referred to as “QUERY” hereinafter and defined below) from an organism of interest is converted into a complete, chimeric full-length gene sequence (referred to as “CHIMERA” hereinafter) by adding the missing terminal sequence regions from a homologous gene model (referred to as “HIT” hereinafter and defined below) from a different organism, preferably a closely related organism. In addition, minor sequence errors, such as frame shifts, can be curated during this process.

A partial cDNA gene sequence in this context refers to any cDNA based sequence (e.g. EST, EST-assembly), harbouring only a partial gene, but which may also contain terminal non-coding regions, like transcribed but untranslated regions, and may also contain sequence errors, like base insertions or deletions, e.g. as a result of sequencing errors or in vitro cDNA synthesis. A gene model refers to a DNA sequence encoding a full-length protein, and starts with the start-codon, ends with the stop-codon, and does not contain any non-protein encoding segments. CHIMERA are only produced for partial cDNA genes which are assumed to be proteinencoding, and only in those cases where the homology to the HIT matches defined criteria as described below. The computational method according to the invention can be carried out as a multi-step-process.

The invention also covers a computer program with program coding means which are suitable for carrying out a process according to the invention as described above when the computer program is run on a computer. The computer program itself as well as stored on a computer-readable medium is claimed.

Further features and embodiments of the invention will become apparent from the description and the accompanying drawings.

It will be understood that the features mentioned above and those described hereinafter can be used not only in the combination specified but also in other combinations or on their own, without departing from the scope of the present invention.

The invention is schematically illustrated in the drawings by means of an embodiment by way of example and is hereinafter explained in detail with reference to the drawings. It is understood that the description is in no way limiting on the scope of the present invention and is merely an illustration of a preferred embodiment of the invention.

### BRIEF DESCRIPTION OF THE DRAWINGS

In the drawings,

FIG. 1 is a diagram depicting in a schematic manner the basic principle of the present invention;

FIG. 2 is a schematic illustration of a computer system that may be used for carrying out the present invention.

FIG. 3 is a more detailed diagrammatic illustration of the present invention.

FIG. 4 is a table identifying organism combinations which were used in an embodiment of the invention for QUERY/HIT identification.

### DETAILED DESCRIPTION

The present invention automates parts of patent applications by organizing relevant sequence information including DNA and protein sequences as well as sequences from similarity searches and primer, consensus and pattern sequences. Sequences can be entered manually or uploaded from other bioinformatics applications such as the BioRS™ Integration and Retrieval System and the Pedant-Pro™ Sequence Analysis Suite.

In the following the invention is referred to as Patent Tool, wherein it has to be understood that the “Patent Tool” is one possible embodiment of the invention and that other embodiments lying within the scope and the spirit of the present invention and as claimed in the attached claims are possible and can be realized by a person skilled in the art.

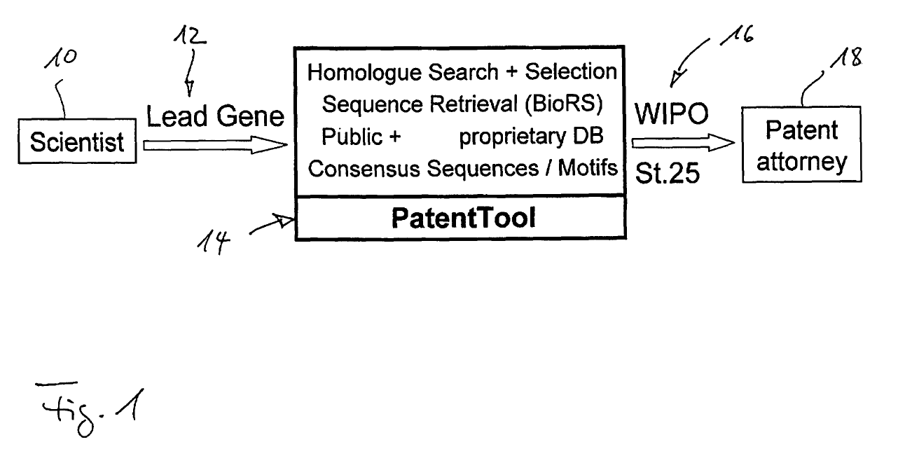

As illustrated in FIG. 1, a scientist 10 or any other user wishing to prepare a patent application on a sequence identifies a lead gene 12 or a primary sequence and inputs the selected lead gene 12 into the Patent Tool 14. In the Patent Tool according to the invention, a homologue search is performed and homologues are selected, sequences are retrieved by means of public and proprietary databases, and consensus sequences and patterns are identified. The detailed way of operation if the invention is described in more detail farther below.

As shown in FIG. 1, the output of the Patent Tool is a standardized format 16 according to the WIPO standard, and this output 16 is forwarded to the Patent attorney 18 for further processing. It is to be understood that the term “forwarded” includes any type of forwarding including manual forwarding, hardcopy forwarding or softcopy (i.e. electronic) forwarding. Of course, the Patent Tool can be easily adapted to other current or upcoming sequence standards, if necessary.

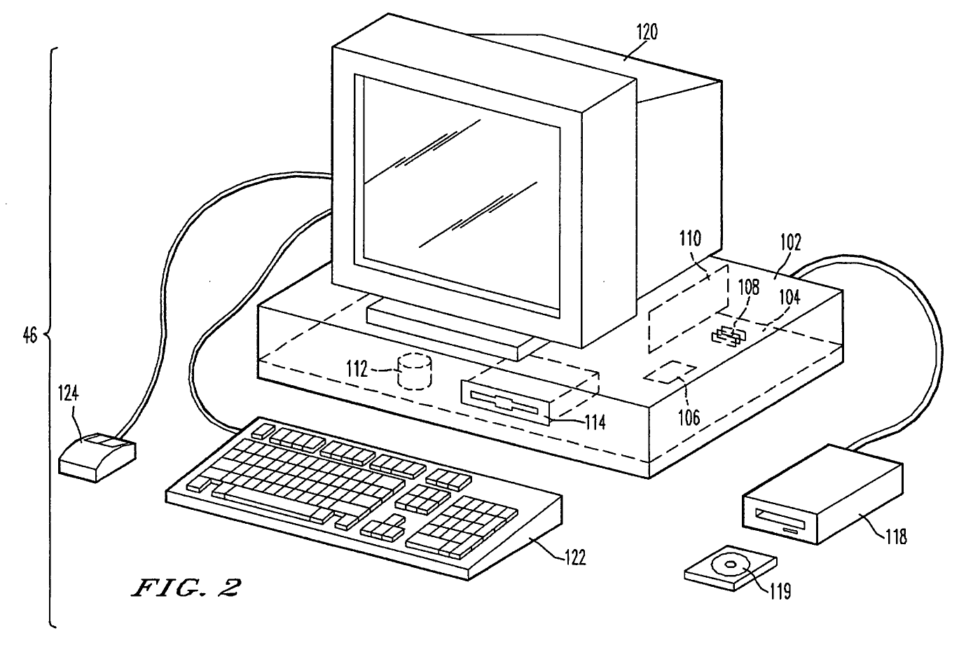

FIG. 2 is a schematic illustration of a computer system that may be used for carrying out the invention. A computer 100 implements the method of the pre-sent invention, wherein the computer housing 102 houses a motherboard 104 which contains a CPU 106, memory 108 (e.g., DRAM, ROM, EPROM, EEPROM, SRAM, SDRAM, and Flash RAM), and other optional special purpose logic devices (e.g., ASICs) or configurable logic devices (e.g., GAL and reprogrammable FPGA). The computer 100 also includes plural input devices, (e.g., a keyboard 122 and mouse 124), and a display card 110 for controlling monitor 120. In addition, the computer system 100 further includes a floppy disk drive 114; other removable media devices (e.g., compact disc 119, tape, and removable magneto-optical media (not shown)); and a hard disk 112, or other fixed, high density media drives, connected using an appropriate device bus (e.g., a SCSI bus, an Enhanced IDE bus, or a Ultra DMA bus). Also connected to the same device bus or another device bus, the computer 100 may additionally include a compact disc reader 118, a compact disc reader/writer unit (not shown) or a compact disc jukebox (not shown). Although compact disc 119 is shown in a CD caddy, the compact disc 119 can be inserted directly into CD-ROM drives which do not require caddies. In addition, a printer (not shown) also provides printed listings of the results of searches etc. so that the user may compare that data entered into the process with that data actually desired entered by the user. The computer system can be connected to an external database or the internet in order to retrieve sequence information from any possible source.

As stated above, the system includes at least one computer readable medium. Examples of computer readable media are compact discs 119, hard disks 112, floppy disks, tape, magneto-optical disks, PROMs (EPROM, EEPROM, Flash EPROM), DRAM, SRAM, SDRAM, etc. Stored on any one or on a combination of computer readable media, the pre-sent invention includes software for controlling both the hardware of the computer 100 and for enabling the computer 100 to interact with a human user. Such software may include, but is not limited to, device drivers, operating systems and user applications, such as development tools. Together, the computer readable media and the software thereon form a computer program product of the present invention for carrying out correlation and comparison between the inputted objective and subjective data with the empirically derived database. The computer code devices of the present invention can be any interpreted or executable code mechanism, including but not limited to scripts, interpreters, dynamic link libraries, Java classes, and complete executable programs.

Patent Tool allows pools of information for patent application to be organized according to biological significance (such as biochemical function or phenotype). Relevant information, including sequence alignments and primers, can be added and organized in the pool. The information can be saved to a text file, which can be manually edited. The resulting text file contains the information necessary for the World Intellectual Property Organization Standard 25 (WIPO St25) form required to apply for patents on sequences.

Patent Tool may be implemented as a clientserver application (not shown). As an example, the following server-side requirements may be supported: SuSE® Linux® Enterprise 9, MySQL™ version 4, Apachem version 3.28 and newer, BioRS version 5.4 for data retrieval, and any other appropriate server/software.

Patent Tool may be accessed using a common web browser (e.g. Internet Explorer). It can be accessed directly from other programs, like the BioRS Integration and Retrieval System or the Pedant-Pro Sequence Analysis Suite.

According to the invention, all information for a single patent application is stored in a data substructure called “patent pool” or just “pool”. When a new sequence for patenting is selected, a pool is created containing the selected lead gene sequence. A “pool can consist of one or more primary sequence with their associated information and can be created at any stage during the process.

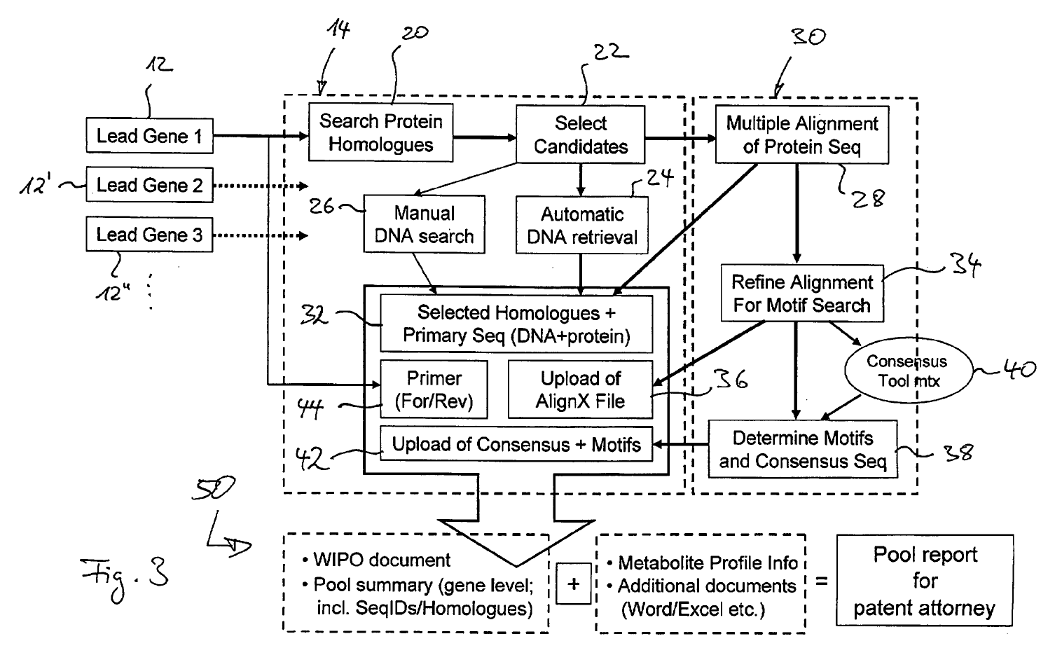

As schematically illustrated in FIG. 3, a selected lead gene 12 is input into a pool of the Patent Tool 14 together with all required and appropriate information such as name, function, sequence etc. (cf. also below), and at 20 a search for protein homologues is performed (e.g. via cross links pointing to original databases). Alternatively searches for homologues sequences can also be performed on the nucleic acid level. The result of the search is checked and appropriate candidates for the homologues to be added to the pool are selected at 22. At this stage, it may be possible to provide an editor for editing the protein sequence information and/or add additional protein sequences. Then, DNA retrieval is performed automatically at 24. In the rare cases in which the automatic DNA retrieval should be unsuccessful, a manual DNA search at 26 could be performed. The DNA search, e.g. via the BLAST tool, is described in more detail below. In an alternative embodiment searches for homologues sequences can also be performed on the nucleic acid level and protein sequences are generated through organism specific sequence translations.

As a next step, a multiple alignment of protein sequences is performed at 28. The latter step can be performed either in the Patent Tool or, as depicted in FIG. 3, outside of the Patent Tool, e.g. through the AlignX function in the Vector NTI environment 30 (Invitrogen GmbH, Karlsruhe, Germany).

The results of steps 24 (or 26) and 28 are then added to the pool at 32.

Further, at 34 the alignment of step 28 is refined for a pattern search the result of which is then input to the pool at 36. The result of the pattern search 28 is also taken as a basis for determining patterns and so-called consensus sequences at 38. The latter can be performed with the aid of a consensus tool 40 which can be part of the external tool 30 but can also be integrated in the Patent Tool 14.

The result of step 38, i.e. the determining of patterns and consensus sequences is then uploaded into the pool at 42.

At 44, the primer information related to the lead gene 12 is additionally imported directly.

The procedure as described may then be repeated for any number of lead genes 12′, 12″, . . . at the discretion of the user.

Finally, at 50, the Patent Tool 14 outputs a pool summary and/or a WIPO adapted document. All output documents constitute the pool report which forms the basis for the patent attorney's work and is accordingly forwarded to him or her.

The invention also provides for a pattern evaluation. One (or several) pattern results from the analysis of multiple sequence alignments or from analysis of non-aligned protein sequences. Each pattern is stored in reference to a consensus sequence (and thus to a given set of protein sequences) in the pool. With the pattern evaluation, it becomes possible to perform a pointed or selected search for small but however relevant functional equality (or consistency). The result of the pattern evaluation provides the sequence name of the evaluated primary or homologue, the number of patterns which did not match as well as an indication (e.g. by means of an icon) for a matching pattern, preferably together with a link to the match. Furthermore, the patterns are used to search any available database and results in a list of database entries which contain all or less than all motifs on a single polypeptide chain. These database hits can be selected and added to the list of homologues as described previously.

Coming back to the general description of the invention, all existing pools are listed in the “Pools” page of the Patent Tool which page is available by clicking the “Select Pool” button in the top navigation bar. A pool can be selected by clicking the pool name in the “List of patent pools” table. The file structure of a pool can be viewed in the tree frame or accessed via web forms in the content (right) frame. Each pool is listed under the Patent Tool user (top-level) folder. A pool contains primary sequence projects. Each primary sequence project may contain folders for similarity search results (“Analysis”), consensus sequences (“Consensuses”), similar sequences (“Homologues”), primer sequences (“Primer”), primary sequences (“Sequences”), multiple sequence files (“MSF files”), and all-against-all distance matrices (“Needle matrix”). When an item in the tree is selected, the item may be highlighted, e.g. in yellow or any other suitable colour, for orientation.

Pools according to the invention are theme-centered sequence collections intended for inclusion in a patent application. Pools may contain one or more primary sequence folders which contain information about the primary sequences (protein, genomic DNA or coding DNA).

Within the primary sequence folders, the following folders may be available:

“Analysis” folder—results from Basic Local Alignment Search Tool (BLAST) similarity searches using the primary sequences and from automatic retrieval of corresponding DNA sequences (if a cross-reference check for corresponding DNA sequence was not successful); furthermore, the import of homologous sequences is stored as log files in this folder;

“Consensuses” folder—consensus sequences, associated patters, and pattern evaluations;

“Homologues” folder—sequences selected from the BLAST results or from manual sequence uploads as well as the global alignments between primary and similar sequences and from automatic retrieval of corresponding DNA sequences (if a cross-reference check for corresponding DNA sequence was not successful);

“MSF” folder—multiple sequence alignment and the possibility to calculate additional consensus sequences at a user-defined identity value (e.g. 100% identity consensus);

“Needle matrix” folder—all-against-all distance matrix based on global alignment;

“Primer” folder—primer sequences;

“Sequences” folder—primary sequences.

These various folders are described in more detail farther below.

General information about a given pool may be displayed on an “Overview” page, including the pool's status (locked or not locked), a description of the pool, user-defined WIPO St25 values and a list of the submissions to and files contained in the pool. The following WIPO St25 values may be listed:

<110> Applicant name

<120> Title of invention

<130> File reference

<140> Current patent application

<141> Current filing date

<150> Earlier patent application

<151> Earlier patent application filing date

The following information may be listed in the “Submissions” table:

Counter

Locked status (locked or not locked)

Number of primary sequences

Current <210> (starting WIPO sequence identifier of the submission)

Maximal <210> (maximum WIPO sequence identifier of the submission).

Files uploaded to the pool may be listed in a section “Files for <pool name>”.

When a pool is locked, the data added to the pool previous to locking are set to “read only.” Locking of a pool means that no changes (e.g. modify description, run analyses or delete) to certain data in the pool can be made any more. These data may comprise the following:

The seq ID in field 210 (the order of the sequence entries in the sequence protocol must be maintained in a given pool in order to not change the numbering when a new sequence is added at a later stage)

Primary sequences

Homologues

Pattern

Multiple alignments

Consensus sequences

Primer

Files

However, data may be added to a locked pool. In such a case, a new “Submission” section is created in the pool and subsequent uploads are loaded into said section until the submission is locked. The “Submission” sections are available as separate sections for download. WIPO sequence identifiers (IDs) for a submission can be set independently of the previous submission(s) in the pool (beginning with an ID higher than the previously highest ID).

Only an administrator can unlock a pool (i.e., the last locked submission, if no open submission exists).

Information about the submissions to the pool can be displayed. Information about the sequences in each submission can be downloaded in WIPO or Excel format. Additionally, information about the primary sequences can be displayed.

Sequences may be added to an existing pool. The following points may be available for adding sequences:

Uploading sequences from other applications;

Uploading sequences via the pool “Primaries” page;

Uploading sequences via the pool “Upload” page;

Uploading sequences from the command-line interface;

Linking primary sequences to pools.

Uploading sequences from other applications

When a sequence is selected in another application (for example, the BioRS system or the Pedant-Pro system) and exported to the Patent Tool, it is available from the upload pages of the Patent Tool.

To export a new sequence to the Patent Tool, the sequence is selected in the other application (the BioRS system or Pedant-Pro system) and exported using the application's export function.

### Uploading Sequences Via the Pool “Upload” Page

A sequence might be uploaded “manually”. In this case, the pool to which the sequence is to be added is selected, and a form for uploading items to the selected pool is displayed, e.g. on the monitor 120.

The following information can be entered in the “Format sequence” section of the form for uploading a single sequence:

Name of sequence (name that will be displayed in the tree frame);

Description of sequence (optional description of the uploaded sequence);

Paste a sequence (sequence specified using one of the following options: get sequence from clipboard; upload a file containing a single sequence; fetch a sequence from BioRS; fetch a sequence from Pedant-Pro; paste sequence).

DNA or protein sequences can be entered as plain text, European Molecular Biology Laboratory (EMBL) format or FASTA format. The sequence in the “Paste a sequence” field can be modified.

To test the entered information for upload, a “Check” can be initiated. The sequence is checked for Open Reading Frame (ORF) completeness and consistency between the DNA coding sequence (CDS) coordinates and the protein sequence. A message about the state of the entered information will be displayed at the bottom of the form. If it is not already in EMBL format, the sequence must be converted, a function which is also provided by the Patent Tool. A message about the state of the conversion will be displayed at the bottom of the form.

After the sequence has been checked and converted to EMBL format, the upload of the sequence into the active pool can be started. The uploaded primary sequence will be displayed in the tree frame under the active pool.

Analogically, multiple sequences may be uploaded.

### Linking Primary Sequences to a Pool

Primary sequences and associated information (homologue sequences, consensus sequences, patterns, and primers) that have been uploaded can be linked to a pool.

To link a primary sequence including associated information to one or more pools in the “Pools” page, the pool(s) can be selected e.g. by clicking appropriate check box(es) displayed on the monitor and the desired primary sequence (selection by clicking) and execute the linking, e.g. by clicking an appropriate “Link” button.

Working with Primary Sequence Data

Primary sequences are sequences submitted at the primary level of a pool. Connections to another sequence on the same level within the same or other pools are not retained. Other types of sequences and information may be associated with primary sequences, including the following:

Consensus (may be manually uploaded);

patterns (may be manually uploaded);

Homologue (similar sequence, which may be manually selected from a BLAST result of the primary sequence or uploaded);

Primer (may be manually uploaded);

Files (may be manually uploaded).

An overview of a primary sequence project can be displayed e.g. by clicking the primary sequence in the tree frame on display and the “Overview” tab in the right frame. Information about the primary sequence is displayed including the following:

Sequence name

Status—radio buttons and the “Set status” button to set the sequence to one of the following:

PATENT_PRIMARY_NEW (new primary sequence);

PATENT_PRIMARY_IN_WORK (primary sequence with a running analysis);

PATENT_PRIMARY_ON_HOLD (primary sequence for which the analysis has been paused);
PATENT_PRIMARY_COMPLETE (primary sequence with a completed analysis);

PATENT_PRIMARY_CANCELLED (primary sequence which has been cancelled and will not be included in the WIPO St25 form);

Statistics—number of and links to the following:

Pools;

Sequence;

Primer;

Homologues;

Consensuses;

Patterns;

Project description (description of the primary sequence);

Sequence check (results of a sequence check for ORF completeness and consistency between the DNA CDS coordinates and the protein sequence and a button to perform a new check);

User-defined WIPO St25 values;

Sequence information (information about each sequence);

Primer (manually uploaded primer sequences associated with the primary sequence and a button to add a primer sequence);

Files (manually uploaded files associated with the primary sequence and a button to add a file).

The “Statistics” table provides a selection to display the following pages for the primary sequence:

Pools—(“Pools” page)

Sequence (“Edit” page)

Primer (“Overview” page);

Homologues (“Homologues” page)

Consensuses (“MSF/cons/patterns” page)

Patterns (“MSF/cons/patterns” page).

The following information, when available, may be listed in the “Sequence information” table:

Category (information about the sequence (e.g., DNA, protein, DNA & protein and EMBL));

DNA source (database from which DNA sequence was originally retrieved);

DNA source ID (ID of the original DNA database entry);

Protein source (database from which protein sequence was originally retrieved);

Protein source ID (ID of the original protein database entry);

Translation table (genetic code used to translate the DNA sequence);

Codon start(frame) (frame in which the coding sequence starts);

EC number (Enzyme Commission number of the protein).

The following information, when available, may be listed in the “Primer” table:

Name (sequence name (defined in the Patent Tool) and a link to the sequence);

Seqs (number of sequences);

Source (original name of the sequence in the application from which it was imported (BioRS system or Pedant-Pro suite));

Type (type of sequence (DNA or protein));

Attribute (detailed information about the sequence format (e.g., DNA, protein, coding sequence and EMBL));

Description (description of the sequence);

Creation (date the sequence was uploaded).

Other sequences (e.g., homologues, primers and consensus sequences) can be associated with a primary sequence.

### Analysis Folder

The Patent Tool allows the following types of analyses:

“BLAST” searches using the primary sequences as query sequence

“Needle matrix” analyses to align primary sequences and homologues and create an “all-against-all” Needleman-Wunsch identity matrix

“FindDNA” analyses to determine the DNA sequence of an uploaded primary protein sequence

Target databases and search parameters can be configured. The results of the “BLAST” searches and “FindDNA” analyses can be accessed e.g. via the “Analysis” folder on display (for example in the tree frame).

Accordingly, “Needle matrix” analysis results can be accessed e.g. via the “Needle matrix” folder on display, such as in the tree frame.

Depending on the type of analysis, the following information may be available from the result table:

Mark (check box to select the hit sequence for uploading or merging using the buttons above the table);

Organism (organism of the hit sequence);

Hit (database and accession number of the hit sequence and a link to the BLAST output);

Description (short description of the hit sequence provided by the hit database and a graphical representation of the alignment length and quality; blue bars represent the alignment of the sequence to be included in the patent document with the primary sequence of the BLAST results);

Ident (%) (pseudo global percent identity determined by tiling the high scoring segment pairs (HSPs) of the query and the hit sequences);

Score (BLAST alignment score of the best HSPs);

Length (length of the hit sequence);

HSPs (number of high scoring segment pairs).

For “BLAST” analyses, several options are available above the table of results: “Choose homologue type” and “Choose homologue acceptance status”.

“Choose homologue type” provides four values available from a drop-down menu and results can be uploaded:

as “A (public, complete)” (homologous sequences are marked with an “A” indicating import of complete, e.g. full length sequences from public sources),

as “B (proprietary, complete)” (homologous sequences are marked with a “B” indicating import of complete, e.g. full length sequences from proprietary sources),

as “C (public, partial)” (homologous sequences are marked with an “C” indicating import of partial sequences from public sources),

as “D (public, partial)” (homologous sequences are marked with an “D” indicating import of partial sequences from proprietary sources); and

“Choose homologue acceptance status” provides two radio buttons: PATENT_HOM and PATENT_CAND. Using these options, results can be uploaded as a “PATENT_HOM” (the sequence is included in the WIPO form) or as a “PATENT_CAND” (the sequence is not included in the WIPO form).

Furthermore, sequences can be either manually selected from the result list or automatically selected. Automatic selection includes selection of all homologues of the result page or sequences above a user-defined threshold for “percent identity” and/or “score”. Selections based on user-defined thresholds can be further limited to pre-defined list of organisms.

### Consensus Folder

The Patent Tool allows consensus sequences to be associated with primary sequences. Information about the consensus sequences can be displayed e.g. by clicking the “Consensuses” folder in the tree frame on display.

Information about the multiple sequence format (MSF) files are listed. To add a MSF file to the pool the “Add” link can be clicked. The MSF consensus sequences are listed. The MSF “Overview” page can be displayed e.g. by clicking the name of the MSF consensus sequence on display. For each consensus sequence the following information may be displayed:

Consensus (the consensus project identifier and a link to the consensus sequence “Overview” page);

Patterns (the name of the pattern, a link to the consensus sequence pattern “Overview” page and the status of the pattern:
PATENT_CAND (patent candidate; sequence will not be added to the WIPO form);
PATENT_PATTERN_ACCEPTED (accepted pattern; sequence will be added to the WIPO form));

Evaluations (the name of the evaluation performed on the patterns and a link to the evaluation “Input” page).

The “Patterns” table may display the following information about the patterns:

Accept (if the pattern status is rejected, a check box to accept the pattern using the “Accept or reject” button above the table);

Reject (if the pattern status is accepted, a check box to reject the pattern using the “Accept or reject” button above the table);

State (status of the pattern: accepted or rejected);

Pattern (name of the pattern and a link to the pattern “Overview” page);

Start (start coordinate of the pattern);

Stop (stop coordinate of the pattern);

Comment (optional comment about the pattern);

Content (content of the pattern).

Patterns can be accepted or rejected by clicking appropriate check boxes in the “Accept” or “Reject” columns, respectively, and clicking appropriate “Accept” or “Reject” buttons above the table.

The “Pattern evaluations” table may list the following information about previous pattern evaluations:

Request (name of the pattern evaluation and a link to the evaluation “Input” page);

Patterns (names of the patterns in the evaluation and links to the pattern “Overview” pages);

Results (a link to the results of the pattern evaluation).

Pattern evaluation may be executed by selecting any or all patterns and defining the number of mismatches in each pattern sequence allowed for the evaluation.

The following information for each primary or homologue sequence may be displayed:

Primary or homologue (sequence name and a link to the sequence “Overview” page);

Non-matches (number of patterns which did not match);

<pattern#> (icon indicating a match (with a link to the match) or a non-match (multiple columns are available, one for each pattern)).

The following information for each pattern may be displayed:

Pattern (pattern name and a link to the pattern “Overview” page);

Matches primary (icon indicating a match to the primary sequence (with a link to the match));

Matches with homologues (number of matches to homologues/number of homologues).

The following information for a pattern search against a non-redundant protein databank may be displayed for complete pattern hits (all patterns are identified in a database sequence) or for incomplete pattern hits (not all patterns are identified in a database sequence):

Hit (a button to display the hit pattern);

Primary or Homologue (sequence name and a link to the “Overview” page of the matching primary sequence or homologue);

Non matches (number of non-matches);

Matches (icon indicating a match to the hit sequence (with a link to the match));

Alignment (a button to display the alignment of the hit sequence with the primary sequence);

Percent identity (percent identity of the hit sequence and the primary sequence);

Percent similarity (percent similarity of the hit sequence and the primary sequence).

The “Pattern evaluations” table lists the following information about previous pattern evaluations:

Request (name of the pattern evaluation and a link to the evaluation “Input” page);

Patterns (names of the patterns in the evaluation and links to the pattern “Overview” pages);

Result (a link to the results of the pattern evaluation as well as the number of false positives, wherein a “Match” button may link to the matches with the primary sequence and the number of false negatives).

### Homologues Folder

Sequences selected from the BLAST results of a primary sequence or added manually to the “Homologues” folder of a primary sequence can be included in the WIPO St25 document. The Patent Tool allows homologue sequences to be associated with primary sequences. Information about the homologue sequences can be displayed by clicking the “Homologues” folder in the tree frame

The following information may be displayed:

Check buttons for the display of different types of homologues; checking of one or more buttons displays only homologs of the corresponding type (A, B, C, or D);

Accept (button to select the sequence to be included in the WIPO document using the “Accept or reject” button above the table);

Reject (button to not include the sequence in the WIPO document using the “Accept or reject” button above the table);

State (selection for WIPO document:
taken (sequence is included in the WIPO form);
rejected (sequence has been manually rejected and is not included in the WIPO form);
undecided (status has not been set and the sequence is not included in the WIPO form; default);
prim (primary sequence, always included in the WIPO form));
A or B or C or D (type of homologue: indicates the origin of homologues as described above; based on the homologue type, the seq-IDs are exported in different tables for overview)

Homologue (name of the homologue sequence hit);

Organism (organism of the hit sequence);

Enzyme name (enzyme associated with the sequence);

EC number (Enzyme Commission number of the enzyme);

Code (genetic code used to translate the sequence);

Check (status of sequence check for ORF completeness and consistency between the DNA CDS coordinates and the protein sequence);

DNA (ID of the original DNA database entry);

Protein (ID of the original protein database entry);

Ident (percent identity of the homologue and the primary sequence);

Sim (percent similarity of the homologue and the primary sequence).

To include the sequence in the WIPO document or reject it, the sequence may be selected e.g. by clicking an appropriate check box in the “Accept” or “Reject” column, respectively, and clicking the “Accept or reject” button. A single or multiple homologue may then be added, e.g. by selecting an appropriate link to display an according form for adding the single or multiple homologue, respectively.

### MSF Folder

Multiple sequence format (MSF) files can be associated with primary sequences.

### Needle Matrix Folder

The needle matrix folder under a primary sequence folder contains the primary sequence “Analysis” page needle matrix information, created as described above in connection with the Analysis folder.

### Primer Folder

Primer sequences associated with primary sequences can be uploaded. The Primer folder contains the according information for uploaded primers, such as name, number of sequences, source, type of sequence, description etc.

### Sequences Folder

A pool can contain several primary sequences: genomic DNA sequence, coding sequence, and protein sequence. The according sequences information is contained in the Sequences folder, including names of the sequences, number of sequences, source, types of sequence etc. The content of the folder can be displayed when clicking on an according button on the display, and it may also be modified. Modifications within the Patent Tool include addition and deletion of DNA and/or protein sequence symbols, modification of name and description of DNA and protein sequences, translation of DNA sequences, database search for corresponding DNA sequences (TBlastN), and identification of open reading frames.

### WIPO Standard 25

The Patent Tool automatically generates a text file in the WIPO St25 format from the information contained in a pool according to the PatentIn 3.1 standard. (PatentIn is a software designed to expedite the preparation of patent applications containing nucleic acid and amino acid sequences and generate sequence listings that comply with format requirements specified in the WIPO St25 and the related United States rule, “Requirements for Patent Applications Containing Nucleotide Sequence and/or Amino Acid Disclosures,” Code of Federal Regulations (CFR) 37 §§1.821-1.825 www.uspto.gov/web/offices/pac/patin/patentin32rel.htm). Of course, the functionality of the patent tool is not limited to the WIPO St25 standard but might be easily adapted to other or upcoming standards.

The form for a pool can be viewed at any time e.g. by clicking the pool name in the tree frame and the “WIPO St25” tab on display.

A table of the sequences may be displayed with the following information:

Seq ID (sequence identifier and a link to display the sequence information in the WIPO St25 form);

Seq name (name of the sequence and a link to display the sequence “Overview” page);

Organism (organism of the sequence);

Type (type of sequence (DNA or protein));

Length (length of the sequence);

Class (classification of the sequence in the patent application (primary sequence, homologue, consensus sequence, pattern or primer)).

The following information and WIPO St25 values, when available, may be displayed according to the Patent Tool input:

Title of the form and the pool

<110> Applicant name

<120> Title of invention

<130> File reference

<140> Current patent application

<141> Current filing date

<150> Earlier patent application

<151> Earlier patent application filing date

<160> Number of SEQ ID numbers

<170> Software

<210> Information for SEQ ID number: <x>

<211> Length

<212> Type

<213> Organism

<223> Other information

<400> Sequence

The last six values are listed for each sequence in the pool.

The form may then be downloaded in one or more formats as required by further processing. The various formats a user may select from can comprise WIPO St25, FASTA, Excel® etc. The selection may be done via a system-specific dialog on display for specifying the name and location for the download. For the WIPO St25 and FASTA formats, the information may be contained in a text editable file.

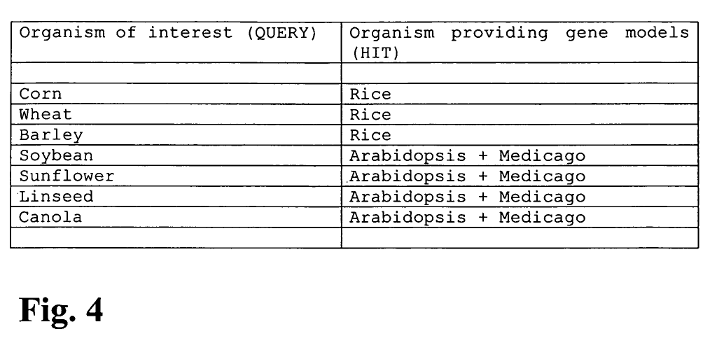

Referring to FIG. 4 now, a computational method for automatically converting a partial cDNA gene sequence (referred to as “QUERY” hereinafter and defined below) from an organism of interest into a complete, chimeric full-length gene sequence (referred to as “CHIMERA” hereinafter) is described. According to the invention. the method comprises the step of adding the missing terminal sequence regions from a homologous gene model (referred to as “HIT” hereinafter and defined below) from a different organism, the latter preferably being a closely related organism. The possible embodiment of the method of the invention as described hereinafter is a multi-step method consisting of five main steps. However, it is to be emphasized that the method is not limited to the described five step process and that the person skilled in the art will be apt to find or develop different embodiments with various number of steps.

### Step 1: Identification of the Best HIT

In the first step, the partial cDNA sequence from an organism of interest is directly compared to all known gene model sequences from a related organism. This comparison is performed on basis of protein sequences, and any suitable bioinformatic standard program (e.g. BlastX) can be used in this first step. Preferably, a fast algorithm is used, most preferably an algorithm which also removes sequence errors, such as FastY (the use of which is described hereinafter; cf. “Comparision of DNA Sequences with Protein Sequences”, W. R. Pearson, T. Wood, Z. Zhang et W. Miller (1997), Genomics 46, 24-36.). The best matching HIT sequence (=gene model), identified by FastY, is used for subsequent CHIMERA creation.

The organism combinations as shown in FIG. 4 were used for QUERY/HIT identification.

The gene models from which HITs were selected were public gene models derived from TIGR4 for Rice, from TIGR5 for Arabidopsis. These relations are part of the design of the described embodiment but can be varied due to the organism of interest (Query) and the availability of organisms for providing the gene models (HIT).

### Step 2: Review of Identified Best HIT

Even otherwise unrelated sequences can match each other in sub-regions with a high degree of similarity, especially if they contain conserved domains like ATP binding domains, and sometimes are identified by some alignment algorithms as best matching sequences. Thus the FastY alignment is further evaluated to accept a HIT only as a homologues gene (and use it for subsequent chimera production) if the following criteria are met both:

“min_identity”: the sequence identity within the FastY alignment has to reach or extend this value (in

“hit_coverage_cutoff_high”: the number of amino acids from the HIT within the FastY alignment has to reach or to extend this value (in %).

The values used in the described embodiment were 50% for (a) and 80% for (b).

### Step 3: Refinement and Curation of Sequence Regions Covered by the Initial HSP

If the criteria of above Step 2 are met both, creation of a CHIMERA is initialized by using the initial FastY protein alignment: the protein alignment shows the region of the HIT protein sequence which is matching the QUERY protein sequence (referred as HSP or HSP region hereafter) and in which the QUERY protein sequence is predicted by FastY from the original QUERY DNA sequence. All cases where FastY proposes to modify the QUERY-DNA sequence for curation purposes (e.g. to insert or delete nucleotides to curate a putative frame shift), are considered for protein prediction and indicated in the protein alignment.

Next, the QUERY DNA sequence is curated based on the translated and corrected QUERY sequence from the FASTY alignment. Therefore it is necessary to align the corrected PROTEIN QUERY sequence and the original DNA QUERY sequence. This can be achieved e.g. by use of an additional program (such as GeneSeqer; cf. 1. Usuka, J., Zhu, W. and Brendel, V. (2000), Optimal spliced alignment of homologous cDNA to a genomic DNA template. Bioinformatics 16, 203-211. 2. Usuka, J. and Brendel, V. (2000), Gene structure prediction by spliced alignment of genomic DNA with protein sequences: Increased accuracy by differential splice site scoring. J. Mol. Biol. 297, 1075-1085. 3. Brendel, V., Xing, L. and Zhu, W. (2004), Gene structure prediction from consensus spliced alignment of multiple ESTs matching the same genomic locus. Bioinformatics 20(7), 1157-1169. 4. Brendel, V. and Kleffe, J. (1998), Prediction of locally optimal splice sites in plant pre-mRNA with applications to gene identification in Arabidopsis thaliana genomic DNA. Nucl. Acids Res. 26, 4748-4757. 5. Brendel, V., Kleffe, J., Carle-Urioste, J. C. and Walbot, V. (1998), Prediction of splice sites in plant pre-mRNA from sequence properties. J. Mol. Biol. 276, 85-104.) which is able to produce an alignment by using protein and DNA sequences as input. Only the sequence regions which are covered by the initial FastY HSP region, are extracted and serve as input for GeneSeqer. The locations where FastY proposes to insert/delete nucleotides to obtain a better predicted protein are now modified in the QUERY DNA sequence, using the GeneSeqer alignment to identify the affected triplet as good as possible.

Any stop codon found in the region of the QUERY DNA sequence which is covered by the HSP is also removed, since chances are considered to be high that such a stop, located within an otherwise conserved region, is more likely the result from a sequence error than of real biological relevance. However, all curation steps are logged as table based output so that a user can subsequently decide if he wants to exclude some created CHIMERA for which some specific curation processes were made, e.g. removal of stops or frame shift corrections. In the described embodiment, stop codons are replaced by a codon encoding glycine. However, a more complex evaluation is imaginable, selecting a different codon, e.g. based on the amino acid which is found in the HIT sequence (when not located in a gap region). Alternatively, a codon might be selected, e.g. based on the amino acid which is found in the HIT sequence.

### Step 4: Creating the CHIMERA

In the most simple strategy, the core of the CHIMERA is made only from the QUERY DNA sequence region (obtained by Step 3) which is covered by the HSP region. The reason for this is that EST-assemblies can show great variations in quality, and also can contain wrongly assembled sequence regions, spanning hundreds or thousands of bases, and which are not desired to be part of the final CHIMERA. Thus, QUERY regions which are flanking the HSP (=do not encode for a predicted protein sequence showing sufficient similarity with the corresponding regions of the HIT sequence to be part of the HSP) might be the result of artefacts within the EST-assembly, and thus are desired to be discarded. On the other hand, in some cases the terminal ends of homologues proteins are found to be less conserved when compared to their otherwise well conserved central regions. In those cases, portions of the QUERY DNA are desired to be part of the final CHIMERA, even if not covered by the HSP region.

The method according to the invention allows the user to choose from two strategies:

(a) only use the QUERY DNA sequence covered by the HSP as CHIMERA-core, then add missing terminal regions by using the DNA sequence from the HIT.

(b) use the QUERY DNA sequence covered by the HSP as CHIMERA-core, but also search for a possible start- and/or stop-codon which are in-frame with the HSP-core, and are found in the HSP-flanking region of the QUERY DNA. If found, use the QUERY DNA for creating the corresponding terminus.

When using strategy (b), the user has to define which regions of the QUERY-DNA sequence are used to scan for a possible start- or stop-codon. A possible start-codon refers to any ATG triplet, which is in-frame with the HSP, located upstream or within the HSP, and no in-frame stop codon is located between said ATG codon and the HSP. A possible start-codon can be searched using the complete QUERY-DNA sequence located upstream of the HSP. Alternatively, the scanned upstream region can be restricted to a defined length (counted in triplets). The latter is especially useful for EST-assemblies of lower quality, since any sequence errors located outside of the HSP (especially frame shifts) are not curated by the curation procedure (as described in step 3), and frame shifts most likely will cause a wrong start or stop prediction. In addition of using only regions upstream of the HSP, the user can extend (or restrict) the region, which is scanned for a possible start-codon, also for a defined number of triplets located inside the HSP region. If more than one possible start-codon is found within the user-defined region, the most upstream located possible start-codon is used for CHIMERA creation. In the same way the user can define whether the complete QUERY-DNA sequence, located downstream of the HSP, is used to search for a possible stop codon, or restrict the region to a defined number of triplets. If no start-codon or no stop-codon was identified, the CHIMERA is produced in the same way like used in strategy (a), which is, using the corresponding termini from the HIT DNA sequence to create a complete but chimeric gene. Using strategy (b) is only recommended when high values are used in step 2, e.g. 50% and 80% for parameter “min_identity” and “hit_coverage_cutoff_high”, respectively. Searching for a start- and stop-codon can be enabled/disabled independently from each other.

It might be preferred to use strategy (b) in combination with settings >=50% and >=80% for “min_identity” and “hit_coverage_cutoff_high”, respectively (see Step 2), using the following settings for searching:

| | |
|---|---|
| search for start codon: | yes |
| region to scan upstream HSP: | restrict to 20 triplets |
| region to scan within HSP: | restrict to 10 triplets |
| search for stop codon: | yes |
| region to scan downstream HSP: | restrict to 20 triplets |

### Step 5: Review of Final CHIMERA

All performed actions can be logged as table based output (e.g. number of bases derived from HIT, number of bases derived from QUERY) from which the user can make a selection which CHIMERA sequences he wants to use for which purpose.

It might be preferred to use CHIMERA only when the number of bases derived from QUERY was >=80%.

Thus, the present invention provides for a helpful tool when preparing biological sequence data for a patent application. Particularly, it allows for a pattern evaluation, and it also allows introducing proprietary sequences and the screening or verifying of their functionalities at a very early stage by adding them to the pool structure of the invention.

1. A method for computer-based processing of biological data, comprising the steps of.
selecting a gene as a lead gene to be patented;
searching homologues for the selected lead gene;
creating a patent pool on the basis of the selected lead gene;
generating and outputting a pool report for a planned patent application.

2. The method of claim 1, wherein the search for homologues for the selected lead gene is performed on the protein level.

3. The method of claim 1 in which the result of the search is viewed and one or more candidates for the homologues are selected.

4. The method of claim 1, in which for each selected homologue candidate, the DNA sequence consistent to the protein sequence is retrieved and added to the same patent pool.

5. The method of claim 1, further comprising the steps of:
performing a multiple alignment of sequences of the selected homologues; and optionally adding the multiple alignment and the derived consensus sequence to the patent pool.

6. The method of claim 1, further comprising the steps of:
extracting one or more pattern from selected homologue sequences; and
adding the extracted patterns to the patent pool.

7. The method of claim 6, further comprising the steps of:
performing a pattern based search for homologues;
adding the resulting homologues of the pattern based search to the patent pool; and
optionally performing an new multiple alignment.

8. The method of claim 6, further comprising the step of mapping of identified patterns onto primary and homologue sequences.

9. The method of claim 1, wherein the pool report comprises all documents to be forwarded to a patent attorney necessary for preparing a complete patent application.

10. The method of claim 9, wherein the pool report comprises a WIPO standard format document.

11. The method of claim 9, wherein the pool report comprises a comprehensive pool summary.

12. A method for computer-based processing of biological data, comprising the steps of:
selecting at least one biological sequence for patenting;
for each selected sequence, creating of a data substructure;
gathering, in the data substructure, of all additional sequence related data required for the planned patent application;
on the basis of the content of the data substructure, generating automatically documents for the patent application.

13. The method of claim 12, wherein the automatically generated documents are in a standardized format.

14. The method of claim 12, wherein the biological sequence selected is a primary sequence.

15. The method of claim 12, wherein the biological sequence selected is a homologue sequence.

16. The method of claim 12, wherein the additional sequence related data comprises primer sequences, consensus sequences and patterns.

17. The method of claim 16, wherein the additional sequence related data is linked to the selected biological sequence.

18. The method of claim 17, wherein the biological sequence selected is a primary sequence.

19. The method of claim 17, wherein the biological sequence selected is a homologue sequence.

20. The method of claim 14, wherein the primary sequence is selected directly in a sequence database and uploaded into the data substructure.

21. The method of claim 20, wherein automatic identification of corresponding nucleotide sequences is performed.

22. The method of claim 14, wherein automatic identification of one or more homologous sequences to the selected primary sequence is performed via a sequence homology search.

23. The method of claim 20, wherein the consistency and completeness of the retrieved information is checked for compatibility to the WIPO standard format.

24. The method of claim 14, wherein a consensus sequence to the primary sequence is deduced and stored in the data substructure within a context relating to the primary sequence.

25. The method of claim 14, wherein a pattern to the primary sequence is deduced and stored in the data substructure within a context relating to the primary sequence.

26. The method of claim 14, wherein the primary sequence is a protein sequence and/or nucleotide sequence.

27. The method of claim 15, wherein the homologue sequence is a protein sequence and/or nucleotide sequence.

28. The method of claim 1, wherein a partial gene sequence is converted into a complete full-length gene sequence of an organism of interest by adding the missing terminal sequence regions from a homologous gene model from a different organism.

29. The method of claim 28, wherein the partial gene sequence is a cDNA gene sequence which is converted into a complete chimeric full-length gene sequence.

30. The method of claim 28, comprising the step of directly comparing the partial gene sequence of an organism of interest to all known gene model sequences of a related organisms or providing organism.

31. The method of claim 30, wherein the step of comparing is performed on basis of protein sequences.

32. The method of claim 30, further comprising the step of further evaluating the result of the step of comparing to accept a gene model of a providing organism.

33. The method of claim 32, further comprising the step of initializing creation of a complete full-length gene sequence by using the gene model determined in the step of evaluating.

34. The method of claim 33, further comprising the step of creating a complete full-length gene sequence.

35. The method of claim 34, wherein the gene sequence of the organism of interest is used as a core for the complete full-length gene sequence and the evaluated gene sequence of the providing organism is added to complete missing terminal regions.

36. The method of claim 34, further comprising the step of searching for a possible matching start and/or stop codon.

37. The method of claim 34, further comprising the step of reviewing the final complete full-length gene sequence and logging all performed actions in a data table.

38. A computer system, comprising:
a CPU, a monitor, an input device, a memory; and
an internal and/or database connected thereto;
further comprising:
a selection module for selecting a gene as lead gene to be patented;
a creation module for creating a patent pool on the basis of the selected lead gene;
a search module for searching homologues for the selected lead gene; and
a generation module for generating and outputting a pool report for the planned patent application.

39. The system of claim 38, further comprising a viewing module for viewing the result of the step of searching and selecting one or more candidates for the homologues.

40. The system of claim 38, further comprising a retrieval module for each selected homologue candidate, retrieving DNA consistent with the protein homologue candidate and adding the same to the patent pool.

41. The system of claim 39, wherein the one or more homologues are protein homologues.

42. The system of claim 39, wherein the one or more homologues are nucleic acid homologues.

43. The system of claim 39, further comprising:
an alignment module for performing a multiple alignment of sequences of the selected homologues, the result of the multiple alignment being added to the patent pool.

44. The system of claim 39, additionally comprising:
a determination module for determining patterns and consensus sequences, the pattern and consensus sequence optionally being stored in the patent pool.

45. The system of claim 44, further comprising:
a search module for performing a pattern based search to obtain matching homologues as to the lead gene and/or homologue sequence.

46. The system of claim 44, additionally comprising:
a mapping module for mapping identified patterns onto primary and homologue sequences.

47. The system of claim 39, further comprising:
an identification module for identifying a pattern from an analysis of multiple sequence alignments or of non-aligned protein sequences, the pattern being stored in the patent pool in reference to a consensus sequence.

48. The system of claim 47, further comprising:
an evaluation module for performing a pattern evaluation to obtain matching motifs as to the lead gene and/or homologue sequence.

49. The system of claim 39, wherein the pool report comprises all documents to be forwarded to a patent attorney necessary for preparing a complete patent application.

50. The system of claim 49, wherein the pool report comprises a WIPO standard format document.

51. The system of claim 49, wherein the pool report comprises a comprehensive pool summary.

52. A computer program comprising program code suitable for carrying out the method according to claim 1 when the computer program is run on an appropriate computer or computer system.

53. The computer program of claim 52, stored on a computer-readable medium.
